(19) United States
(12) Patent Application Publication
(10) Pub. No.: US 2013/0017084 A1
(43) Pub. Date: Jan. 17, 2013

(54) HIGH EFFICIENCY VERICAL AXIS WIND TURBINE

(71) Applicant: Claude Anderson, Arden Hills, MN (US)

(72) Inventor: Claude Anderson, Arden Hills, MN (US)

(21) Appl. No.: 13/182,395

(22) Filed: Jul. 13, 2011

(51) Int. Cl. F03D 7/06

(52) U.S. Cl. 416/1; 416/17

(57) ABSTRACT

A vertical axis wind turbine having a rotor assembly within a support structure supporting a rotor assembly. A directional vane repositions a guide track to maintain a substantially fixed position relative to changes in the wind direction. A blade is rotatably connected to a strut extending from a rotatable shaft. The blade pitch is controllable with a guide pin positioned substantially near the trailing edge of the blade. The guide pin follows a guide track resulting in a blade pitch that may change as the blade rotates through a revolution. Multiple guide tracks may be used to change the blade pitch pattern at a given position as a result of varying operating conditions such as wind velocity. Using guide track pitch control, the drag and lift forces can be optimized for improved starting torque as well as improved lift and reduced drag under high wind velocity conditions.

### BACKGROUND

1. Field of Art

This disclosure relates generally to the field of wind turbines. More specifically, this disclosure relates to a high efficiency vertical axis wind turbine providing a simplified means to optimize lift to drag ratios for enhanced starting capabilities.

2. Description of the Related Art

Wind turbines operate by using the kinetic energy of air flow across a blade to cause a shaft to rotate. The rotating shaft may then be used to produce electricity using an electric generator. Wind turbines are divided into two types, drag machines and lift machines, based on the aerodynamic principles they utilize. Wind turbines are also classified according to their physical configuration as a vertical axis wind turbine (VAWT) or a horizontal axis wind turbine (HAWT). Because of its high efficiency, the HAWT has the most prevalent use, particularly for electrical power generation. The VAWT avoids some of the problems associated with the more common HAWT because a VAWT can be placed closer to the ground it becomes less costly to install and service making it more suitable for urban installations. There a two well known designs for VAWT's.

The Savonius design, U.S. Pat. No. 1,697,574 is an early example of a turbine that relies on drag forces to generate energy. A simple anemometer is another common example. The Savonius design generally starts easily, but being limited to drag forces, it has relatively low energy efficiency. This limitation arises, because as the blades cycle around, they are hurting power output because during a portion of each cycle, they are moving against the wind.

The Darrieus turbine, U.S. Pat. No. 1,835,018 is an example of a turbine that relies on lift forces to generate energy. The Darrieus turbine is more efficient at capturing wind energy, however it requires a relatively high wind velocity to start it turning. As a result, wind energy at low velocities is not captured. This often results in a significant period of time that some wind is present, but the VAWT is not operating again hurting overall power energy efficiency.

Drag forces used in the Savonius design operate in the downwind direction while lift forces of the Darius design operate at right angles to the relative wind direction. Various attempts to design a VAWT that utilize both lift and drag forces to operate, generally result in requiring complicated mechanical systems to adjust the shape and/or pitch of the blades or result in designs in which one feature interferes with the other features degrading overall combined performance of the VAWT.

### SUMMARY

A vertical axis wind turbine (VAWT) and method of operation is provided according to an embodiment of the invention. The VAWT comprises a rotatable shaft and one or more struts coupled to and extending from the rotatable shaft. The VAWT further comprises one or more blades rotatably coupled to the one or more struts. In one embodiment of the VAWT, the pitch of the blades may be controlled at a desired angle which may change as the blades rotate around the shaft. In a further embodiment of the VAWT, the pitch of the blade may be adjusted to change with a change in ambient wind velocity.

A VAWT is provided according to an embodiment of the invention. The vertical axis wind turbine comprises a rotatable shaft and one or more arms coupled to and extending from the rotatable shaft. One or more blades are coupled to the one or more arms at a point of the blade such that the blade may be rotated to achieve an angle of attack associated with a desired lift-to-drag ratio.

The VAWT includes a support structure with a stand. The stand is rotatably connected to portions of the support structure which may be through a structure support bearing. A directional vane positions the rotatable portions supporting the rotor assembly to a known position relative to the ambient wind so that the directional vane remains substantially downwind of the rotor assembly. As a vertical assembly, the VAWT may be mounted on roofs, telephone poles and existing signage to take advantage of local topography and wind flow patterns in urban settings.

A trailing edge of each blade has at least one pin which follows a track in support structure. The track may be used to set the blade pitch at any point along the path of the blade. A plurality of tracks may be used to change the blade pitch at a point along the path. A diverter is used to change the track the blade is following. The diverter may be aerodynamic forces within the blade to move the trailing edge of the blade to another track, or alternatively, the diverter may be a mechanical or electro-mechanical switch to direct the blade for changing wind speeds.

The aerodynamic diverter may be used by coupling the blades at or near a center of pressure point of the blade such that as the velocity of the blade may change, a pitching moment on the blade may develop to move the tail end of the blade in a direction to engage an alternate track associated with the desired lift-to-drag ratio of the blade at the new blade velocity.

When the wind is slow the blade tip guide pins will run on an inner track that utilizes drag and when the wind speeds up they will move to an outer track that utilizes lift and minimizes drag. When the VAWT is running in a given lift track the blades are fixed at a specific angle for any given position around the rotation and do not change angle. Having each blade fixed at each of four corners helps to eliminate the chance of high speed wobble.

The VAWT as described can be constructed with less than 12 structural pieces. This allows for an inexpensive device that can be easily shipped and assembled at a site. Although hardware items would tend to be metal, due to its allowable control of lift and drag forces, the design allows a potential substantial use of plastic materials that may be used in construction provide for an extremely economical device that can be easily attached to an appropriate generator. A further benefit of plastic materials is the ability of plastic to operate without bearings or lubrication because of its high inherent lubricity and low coefficient of friction.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIGS. 1A and 1B illustrate prior art VATW's.

FIG. 2 illustrates a perspective view of an embodiment of a VAWT.

FIG. 3 illustrates a perspective view of an embodiment of a rotor assembly of a VAWT.

FIG. 4 illustrates a perspective view of an embodiment of a support structure of a VAWT.

FIG. 5 illustrates a cross sectional view of an embodiment of a support structure of a VAWT.

FIG. 6 illustrates a side view of one embodiment of a blade a rotor assembly coupling to a strut.

FIG. 7 illustrates one embodiment of a cross sectional view of a portion of a blade of a VAWT.

FIG. 8 illustrates one embodiment of a schematic representation of forces on a blade of a VAWT.

FIG. 9 illustrates an example plan view 210 representation of lift and drag forces on a blade.

FIG. 10 illustrates the overall energy efficiency of selected wind turbines

FIG. 11 illustrates an example of a typical wind speed histogram.

FIG. 12 illustrates an example relationship between drag coefficient and angle of attack.

FIG. 13 illustrates an example of a relationship between lift coefficient and angle of attack

FIGS. 14A-C illustrate examples of blade position on alternative guide tracks.

FIG. 15A illustrates an embodiment of the plan view of a diverter mechanism to direct a blade to the appropriate guide path.

FIG. 15B illustrates an embodiment of a cross sectional view of a diverter mechanism to direct a blade to the appropriate guide path.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying Figures. It is noted that wherever practicable similar or like reference numbers may be used in the Figures and may indicate similar or like functionality. The Figures depict embodiments of the disclosed system (or method) for purposes of illustration only. One skilled in the art will readily recognize from the following description that alternative embodiments of the structures and methods illustrated herein may be employed without departing from the principles described herein.

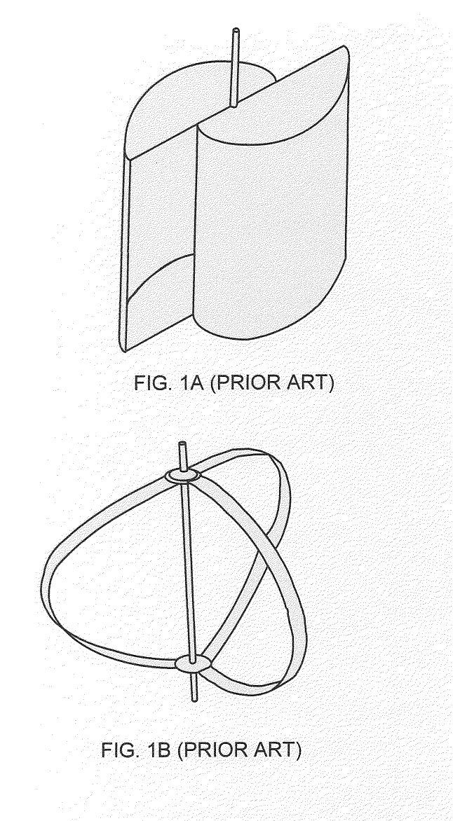

VAWTs offer a number of advantages over traditional horizontal-axis wind turbines (HAWTs). They can be packed closer together in wind farms, allowing more in a given space. This is not because they are smaller, but rather due to the slowing effect on the air that HAWTs have, forcing designers to separate them by ten times their width. VAWTs are rugged, quiet, and they do not create as much stress on the support structure. They do not require as much wind to generate power, thus allowing them to be closer to the ground. By being closer to the ground they do not excessively kill migratory birds, they are easily maintained and can be installed on chimneys and similar tall structures. FIGS. 1A and 1B respectively illustrate a Savonius style and Darrieus style VAWTs. The Savonius design depends on drag forces to provide energy and as shown in FIG. 1A is limited to relatively slow operating speeds. The Darrieus design although capable of operating at higher speeds is difficult to start at low wind speeds. The present invention can operate as an improved Savonius design utilizing full drag forces when a blade is moving down wind, while turning the blade to minimize drag when the blade is in the upwind positions. At higher wind speeds, the present invention can operate as an improved Darrieus design, since the lift forces can be optimized and in fact positive lift and negative lift conditions can be chosen as needed to improve the efficiency of the design. This is accomplished by simply adjusting the pitch of the blade.

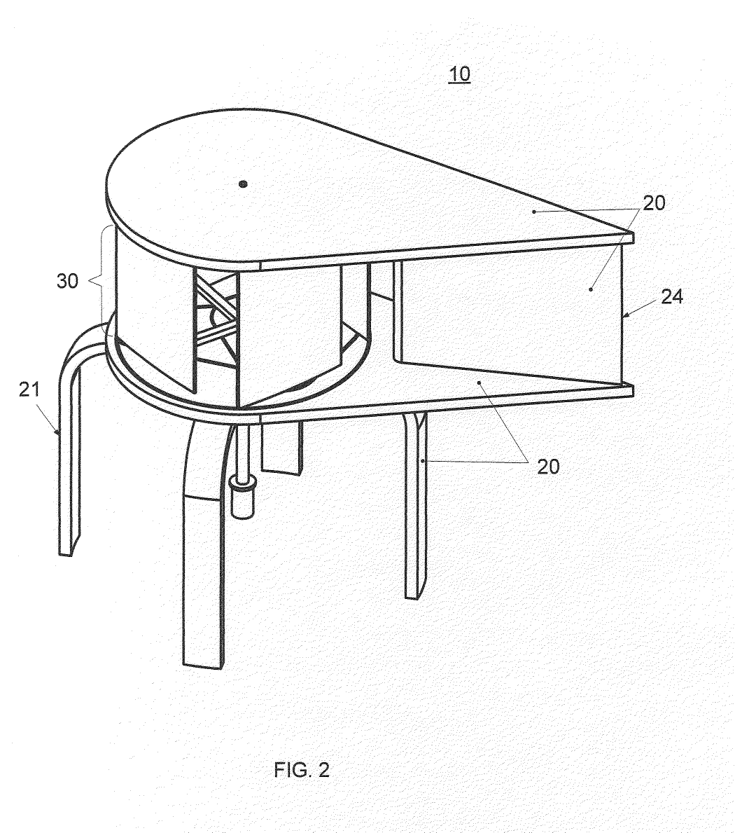

FIGS. 2-8 illustrate various views of embodiments of the disclosure. FIG. 2 illustrates a perspective view of the VAWT 10. A rotor assembly 30 is supported within a support structure 20 so that it may freely rotate independently of the support structure 20. The support structure has a stand 21 that is fixed such as legs, telephone pole, building or existing tower. A rotatable portion of the support structure 20 supports the rotor assembly 30. The rotatable portion includes a directional vein 24 that positions itself in a position substantially downwind from the rotor assembly 30. Since any changes in ambient wind direction are compensated for through the support structure the rotor assembly 30 itself does not have to respond to changes in actual wind direction.

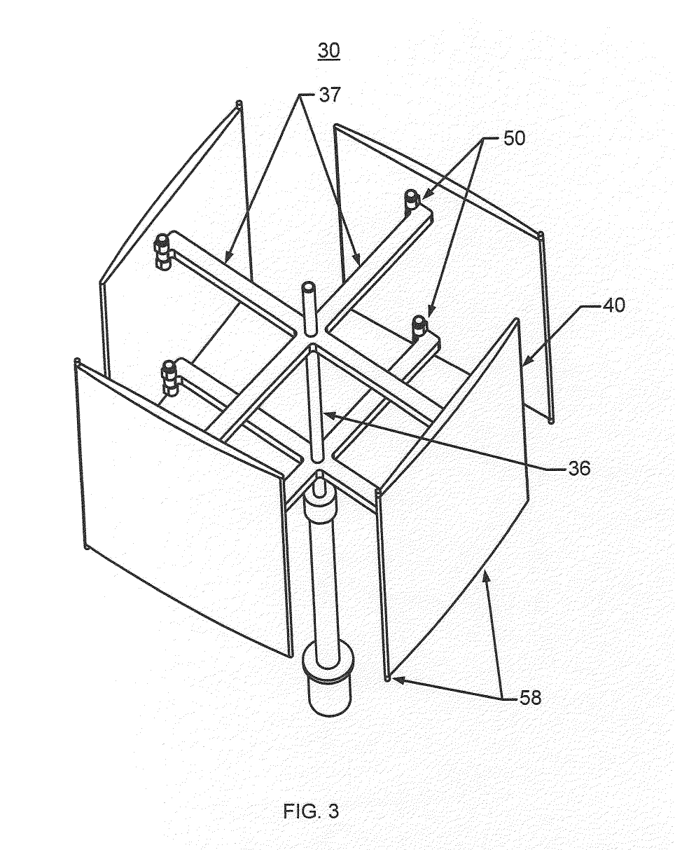

FIG. 3 illustrates a perspective view of an embodiment of a rotor assembly 30 of a VAWT. A shaft 36 running vertically through the VAWT is rotatably supported within the support structure 20. An end of the shaft provides the mechanical force to drive a generator or other mechanical device. A plurality of struts 37 are fixed to the shaft 36 and extend radially from the shaft 36 to a blade 40. Typically a pair of struts 37 is attached to each blade 40 through a swivel assembly 50. The swivel assembly provides a connection that allows the blade 40 to rotate about the strut 37 longitudinal axis. The blade 40 is also provided with a guide pin 58 to provide pitch control of the blade 40 as it rotates about the shaft 36.

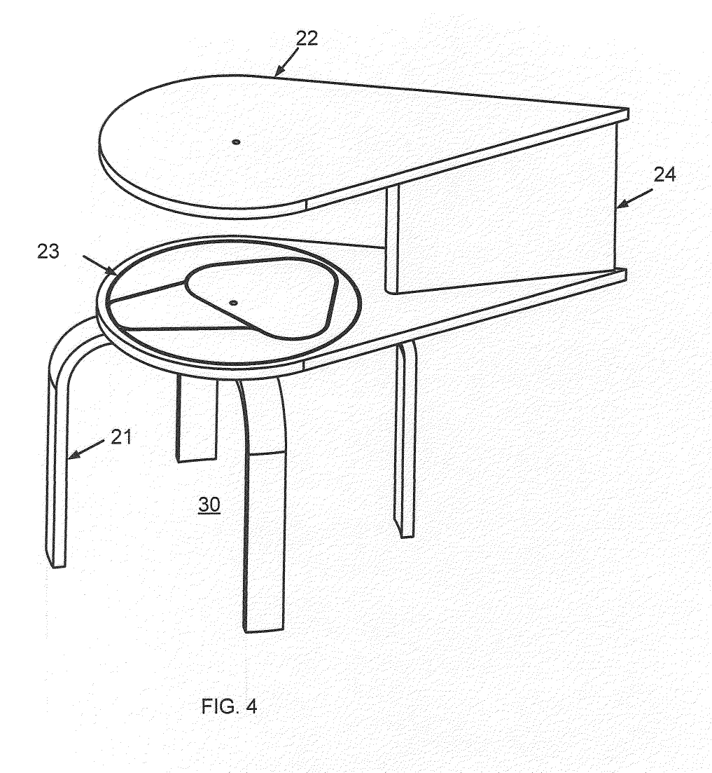

FIG. 4 illustrates a perspective view of an embodiment of a support structure 20 of a VAWT without the rotor assembly 30. A directional vane 24 separates an upper plate 22 from a lower plate 23. Each plate has one or more guide tracks to accept the appropriate guide pin thus controlling the blade pitch at each point in the blades rotation. The upper guide track 25 is a minor image of the lower guide track 26. Multiple guide tracks are provided to provide multiple blade pitches for a blade at a given position in its rotation. A stand 21 provides a fixed support for the rotational portion of the support structure 20. The directional vane 24 orientates the plates so that the guide tracks are generally at the same position, relative to ambient wind, regardless of the wind direction.

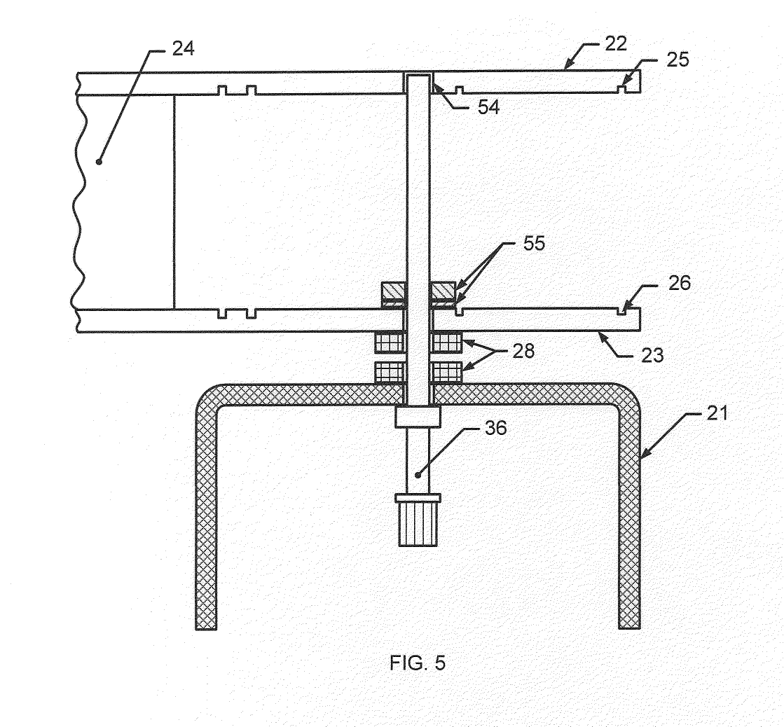

FIG. 5 illustrates a cross sectional view of an embodiment of a support structure of a VAWT. A shaft 36 portion of the rotor assembly 30 rotates within the support structure 20. To support the weight, while minimizing frictional losses and transmitting the power produced, bearings may be used. In one embodiment, a rotor bearing 55 is used between the structure support 20 and the lower plate 23. In other embodiments, the load may be carried by an upper bearing 54 or the bearing may be integral with the attached electrical generator. Optionally, for materials with low frictional coefficients, the bearing functions may be incorporated by the material itself.

As further shown in FIG. 5 as the stand 21 remains fixed, a structural support bearing 28 is provided to allow the rotatable portion of the structural support to rotate into the correct orientation with respect to changing wind conditions.

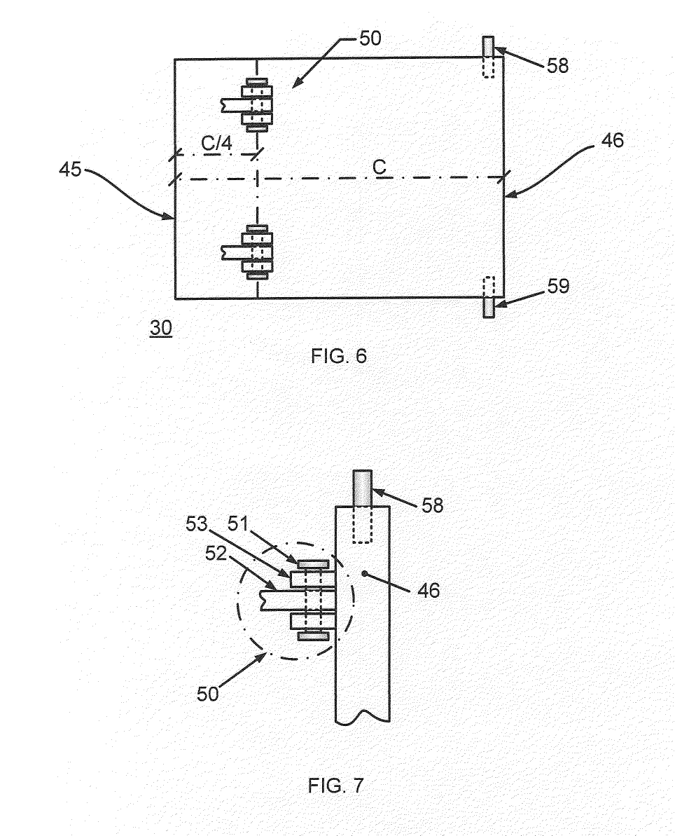

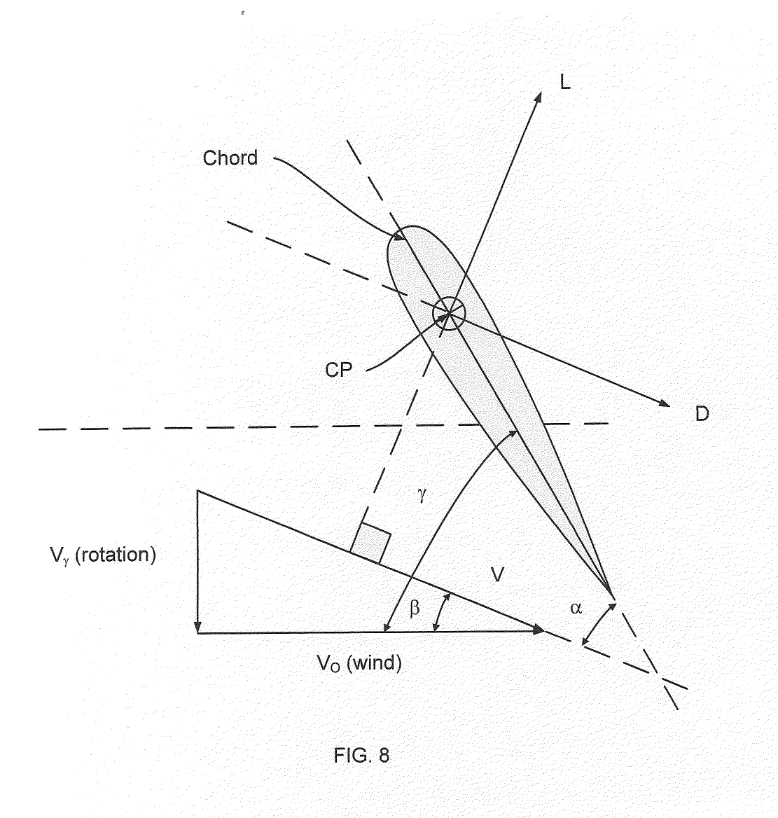

A blade 40 is essentially an airfoil coupled to and rotating around an axis. As an airfoil, the blade may have a shape ranging from a flat plate as shown in FIG. 6 to that of a symmetrical or non-symmetrical airfoil. Streamlined embodiments would tend to have greater lift and less drag. Extensive information is available to estimate aerodynamic properties of specific airfoil designs. This information may be refined using wind tunnel experiments to account for nonstandard conditions and interactions such as wing wash and vortex interference from the upstream blade. As shown in FIGS. 6 and 7, the blade 40 has a leading edge 45 and a trailing edge 46. A swivel assembly 50 allows limited rotation of the blade 40 around a hinge pin 51 connecting at a rotor connector 52 portion attached to the strut 37, and a blade connector 53 attached to the blade 40. The attachment point for the swivel assembly 50 is typically at the ¼ the chord (c) length of the blade 40 nearest the leading edge 45. Near the trailing edge 46 are an upper guide pin 58 and a lower guide pin 59 which are fixedly attached to the blade 40 at one end, with a free end available to freely slide within the appropriate guide track.

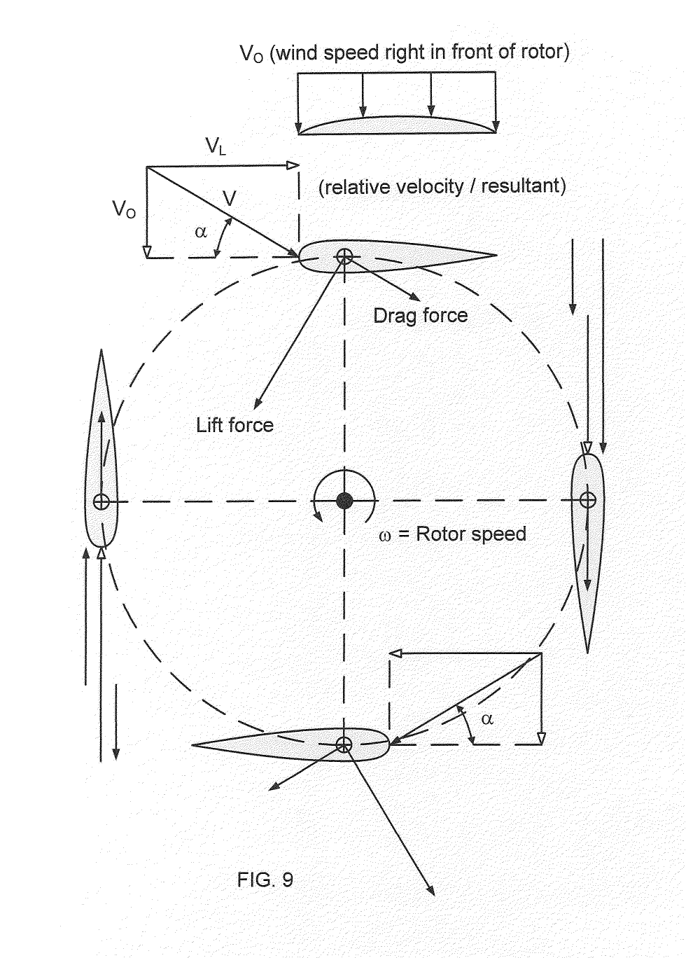

FIG. 8 shows a section view of the airfoil at the radial plane containing the center of pressure (Cp). The Cp is a theoretical point along the cord line where the turning moment (M) is zero. The chord line is the longest line in the cross section joining the leading and trailing edges.

The angle of attack a is the angle the apparent wind direction makes with the chord line. The airfoil shape has inherent lift and drag characteristics, which vary with the incidence angle of the air with respect to the chord of the airfoil. This angle is called the angle of attack, or α. The angle of attack depends on (1) the orientation of the airfoil with respect to the axis of rotation of the blade, angle γ, and (2) the angle of the air flow with respect to this same axis, angle β. Because the blade is rotating around a shaft 40 azimuth (Ω), the air flow angle, β, depends on the motion of the wind and the motion of the blade.

The velocity vectors of the rotation velocity (Vr) of the blade and real wind velocity (Vo) of the wind unaffected by the blade are combined to determine the apparent wind velocity (V). Blade velocities can be normalized by calculating a tip speed ratio (tsr) which is the blade velocity divided by the real wind velocity.

The lift, L, and drag, D created by the apparent wind velocity (V) are perpendicular and parallel to the angle of attack. In addition to wind direction and velocity, lift (L) and drag (D) are a function of the lift coefficient (C_{L}) and drag coefficient (C_{D}) respectively. They depend on the shape of the airfoil and will alter with changes in the angle of attack and other wing appurtenances. In addition, other factors such as vortices and blade wash complicate the analysis of lift and drag.

A lift-drag ratio may be used to express the relation between lift and drag and is obtained by dividing the lift coefficient by the drag coefficient C_{L}/C_{D}.

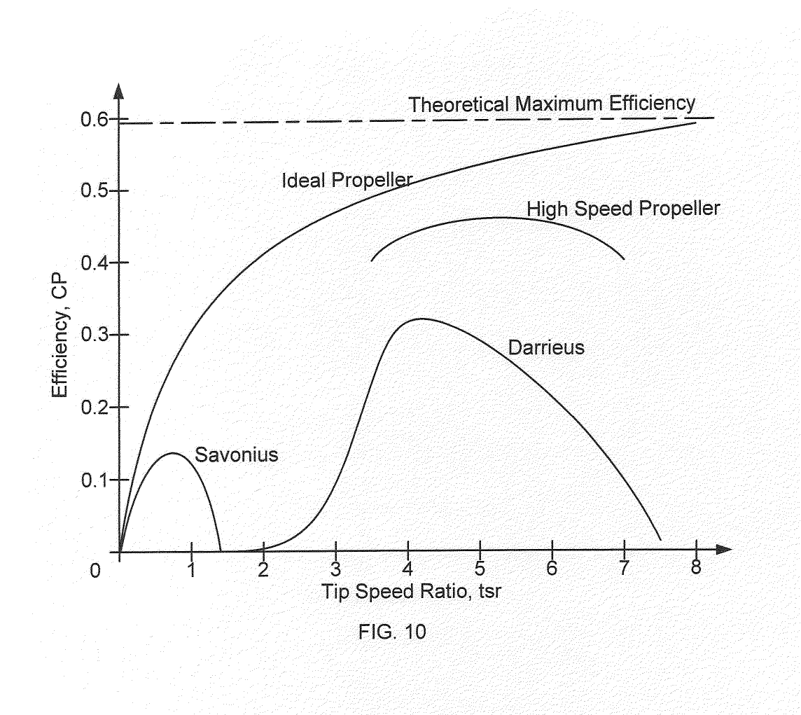

As illustrated FIG. 9 the drag forces operate in the direction of the apparent velocity while lift forces operate at right angles to the apparent velocity. As the blade 40 rotates around the vertical axis, the azimuth is continually changing. As the azimuth changes these forces may assist or restrain the rotation of the blade 40. Changing the pitch of the blade at a given azimuth can be used to affect the lift and drag forces affecting the quantity and amount of forces available for use. Pitch changes can be used to increase the rotational velocity as well as decrease the rotational velocity. Decreases in rotational velocity are particularly helpful during periods of extremely high wind velocities, which may otherwise result in overload and damage to the VAWT.

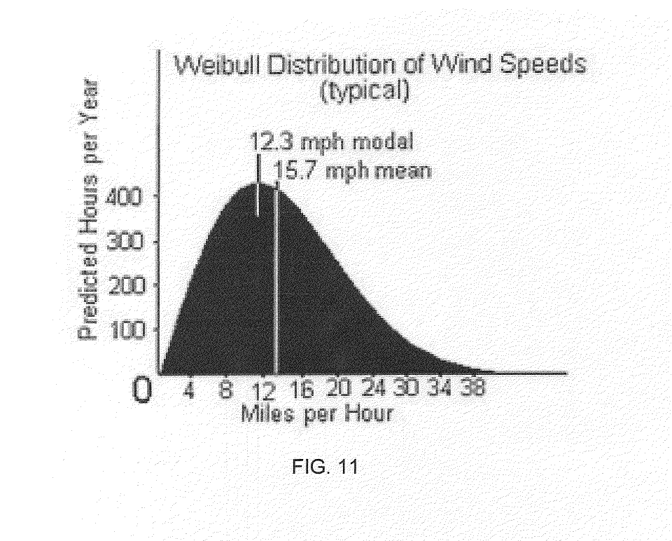

FIG. 10 illustrates an example the overall energy efficiency for selected turbine technologies. The overall power efficiency (CP) represents the ratio of the power extracted from the wind from that which is available. As shown the Savonius (drag) has a high efficiency at low speeds, but it is not effective at high speeds. The Darrieus (lift) unit becomes efficient at higher speeds. The Darrieus unit has significant optimization potential at low speeds and high speeds. The high speed efficiency may be improved by optimizing blade pitch for high speed operation.

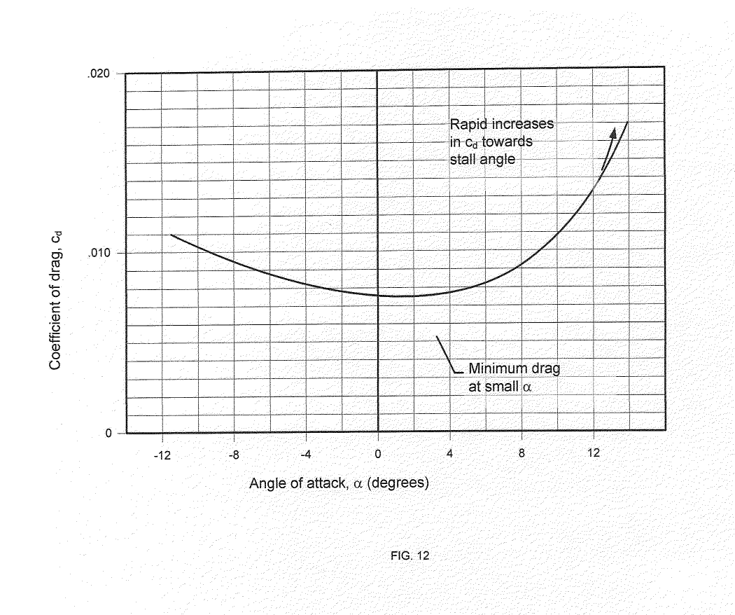

FIG. 11 illustrates an example wind speed histogram as a function of time. As shown, a significant period of operating hours can be lost if a VAWT does not initiate turning at low wind speeds. Furthermore, although very high speed winds may have a low probability of occurrence it is preferable that a VAWT design will be capable of surviving an most occasional high wind speeds without being destroyed.

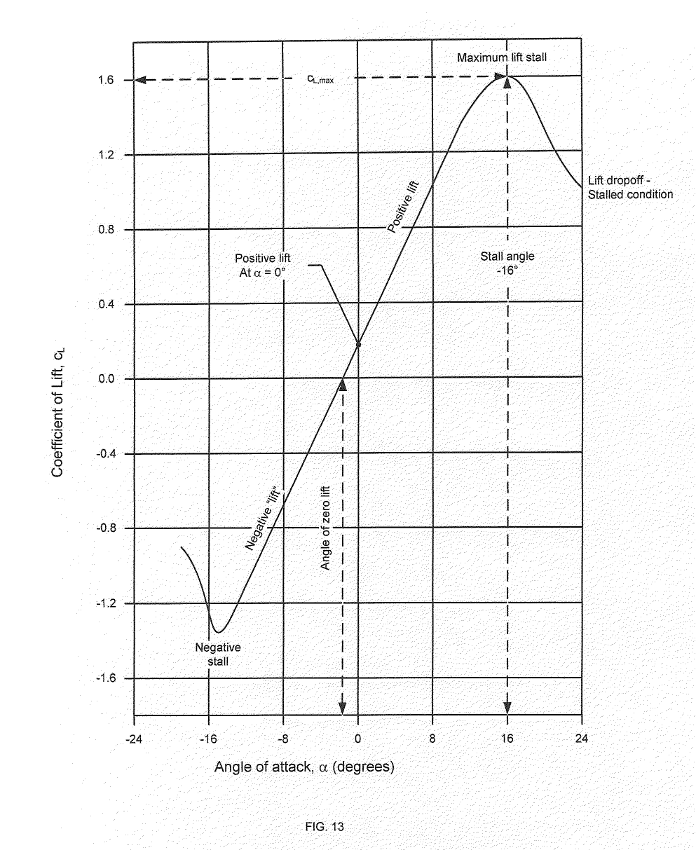

FIG. 12 illustrates an example of change in the angle of the drag coefficient attack for a representative airfoil. For a blade 40 operating in a high lift mode, to minimize drag, the angle of attack would be relatively low. To initially start a VAWT a high drag condition can be obtained by either at high or low angles of attack with the appropriate direction of the force selected by using the appropriate positive or negative angle of attack.

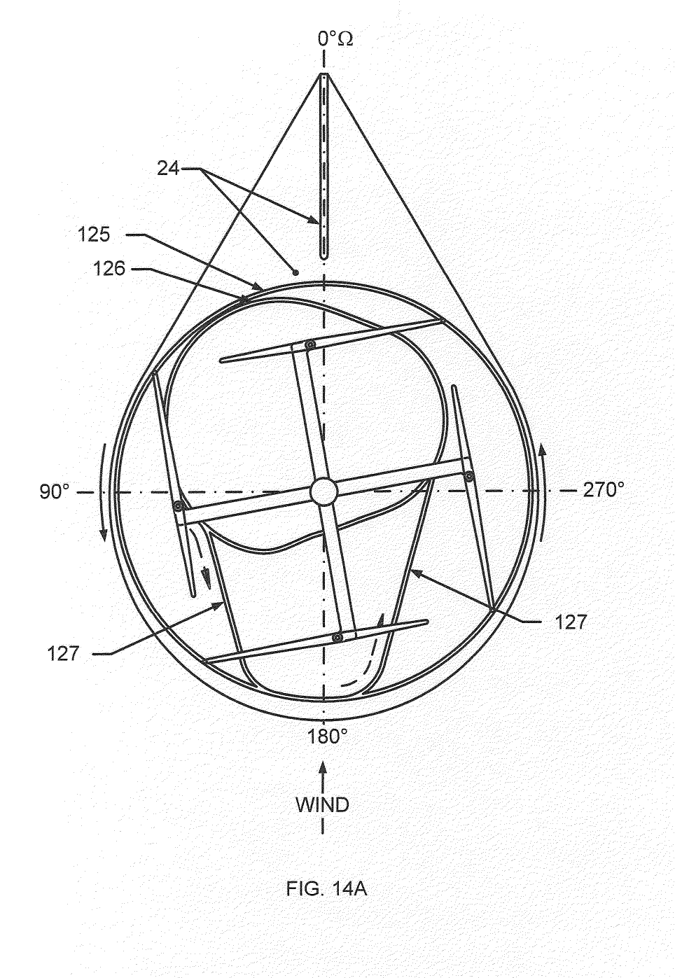

FIG. 13 illustrates an example of lift coefficients at various angles of attack. The lift coefficient is minimal at low angles of attack, which would occur when using the blade in a lift configuration. For this example airfoil, lift is negligible at approximately a −2 degree angle of attack. Negative lift occurs as the angle of attack is decrease. Positive lift occurs as the angle of attack is increased. Of course, higher lift forces also increase drag forces requiring a balancing of the two. In addition, at high angles of attack, excessive turbulence creates a stall condition resulting in a loss of lift. As such, drag dependent devices operating at high angles of attack do not have appreciable lift.

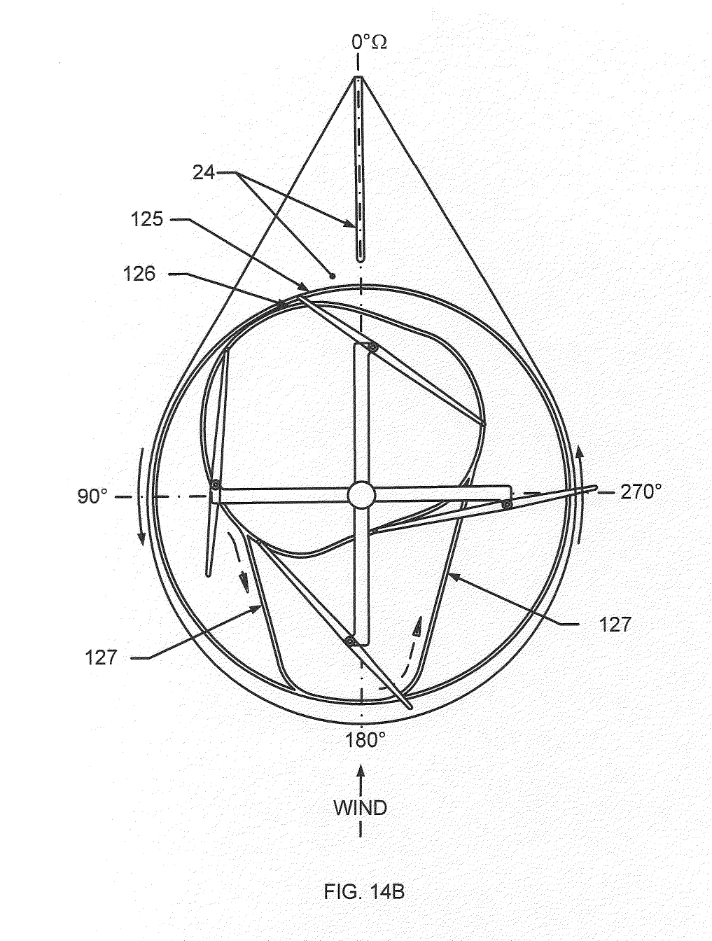

FIGS. 14A-C illustrate examples using guide path pitch control of blade position on three alternative guide tracks. FIG. 14A represents and embodiment in which the blade position is illustrated for various azimuthal positions following a first guide path 125. The guide pins are shown tracking in a substantially circular perimeter track. The blade pitch is set by the position of the guide pins at the trailing edge and the strut attachment area near the center of pressure. For this guide track the radial position of the guide pins in the guide track follow a parallel path to the swivel assembly. As such, the angle of rotation stays relatively constant throughout each revolution. This embodiment would be expected to be highly efficient at higher wind velocities.

FIG. 14B illustrates an example where the blade pitch changes during each revolution. In this example the plates would be configured for high starting capability in low wind conditions. This occurs because the directional vane 24 orientates the plates so that all guide paths remains in approximately the same position relative to the wind. This embodiment shows the use of a second guide path 126, the blade would switch from the first guide path 125 to the second guide path 126 as the blade rotates around the azimuth of the plate. In this embodiment the blade at the 270° position would have a relatively high drag coefficient and not provide any lift force. The blade at the 90° position would have relatively low drag coefficient as the blade moved in an upstream position. Blades at the 0° position and the 180° position have intermediate angles of attack.

FIG. 14C illustrates an example in which the blade would also utilize a third guide path 127, the blade would switch from the first guide path 125 to the second guide path 126 and finally to the third guide path 127. This option provides an intermediate embodiment utilizing both drag and lift forces. In this embodiment may be preferable embodiment for reducing the chance of damage by limiting rotational speeds during occasional high wind conditions.

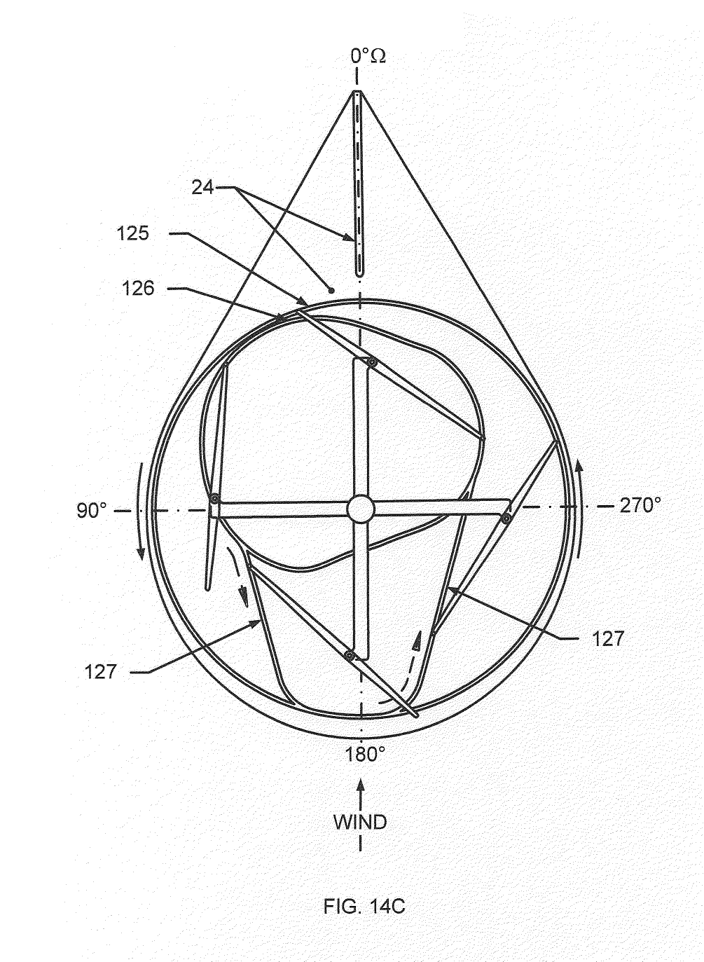

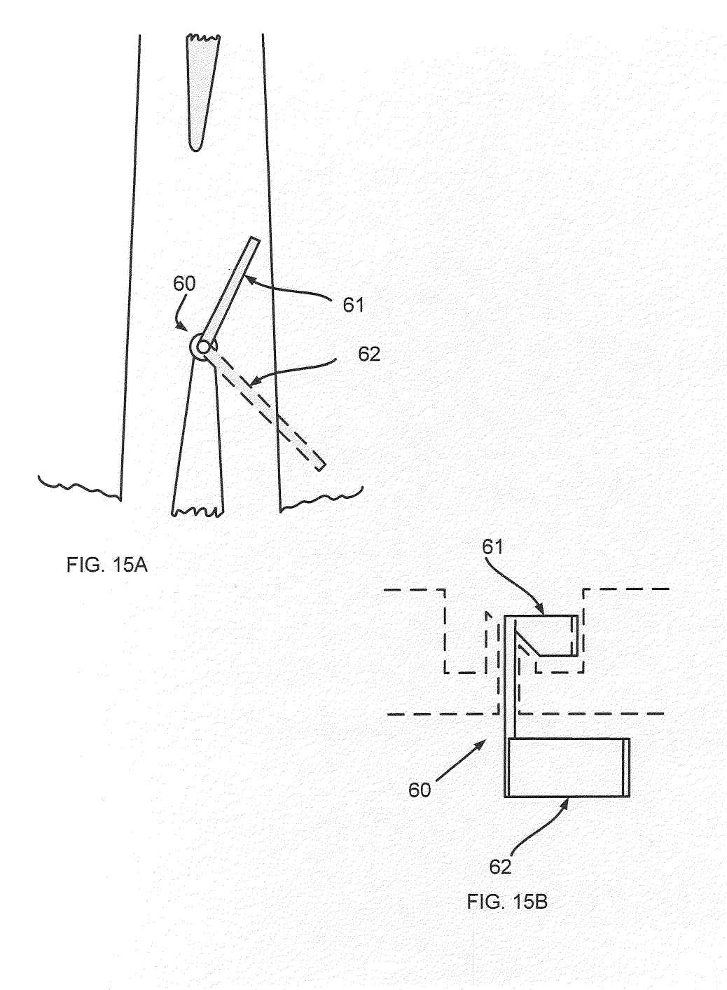

FIGS. 15A and 15B illustrates an embodiment of a diverter 60 to direct a blade to switch to an appropriate guide path. This allows the use of multiple blade pitch settings at a given azimuth position of the blade. The diverter is shown as a mechanical device, however the diverter 60 may be a mechanical or electrical mechanical unit, or may be fully aerodynamic.

According to an embodiment of the invention, the blade 40 is coupled to the strut 37 at the center of pressure Cp. The center of pressure Cp is defined as the point where the blade's pitching moment, M, is approximately zero. For a symmetrically shaped blade the center of pressure Cp will generally be at the quarter chord point, C/4. Coupling the blade 40 to the strut 37 at the Cp would result in the trailing guide pins to essentially follow the guide track without a strong tendency to move toward the inside or outside of the guide track. If the blade 40 is attached through the swivel assembly 50 forward of the center of pressure, the resulting pitching moment M would move the guide pin to the side of the guide path closest to the center of the plates. Alternatively, if the swivel assembly 50 is centered behind the Cp the guide pins will tend to move toward the outer edge of the guide path. As the Cp may change with a change in operating conditions, it may be possible to select an attachment point that will change with operating conditions such as wind speed. As a result, guide paths can be provided with a common segment so that at one wind speed, the guide pin will track to an inner track, while at another wind speed the guide pin will track to an outer path. Thus, alternate tracks are used which are aerodynamically switched from one to the other simply by appropriate selection of the attachment point.

In other embodiments, mechanical and electro-mechanical switches may be used. In an electro-mechanical embodiment, a simple electrical switch calibrated to a wind velocity may be mounted on the VAWT. When activated, this may open or close a simple mechanical or magnetic gate by blocking one guide track thereby directing the guide pin to the selected now open guide track. Such gates may be located within a recess in the bottom of the guide track, or on a side of a guide track.

In FIGS. 15A and 15B, a diverter 60 has a gate 61 that alternatively blocks a first guide track to direct the blade to follow a second guide track. An activator 62 is shown rotatably mounted on the lower plate. The activator is placed so that at a desired wind velocity, sufficient force will rotate the activator 62 thus moving the attached the gate 61 within the common segment of the first and second guide path to alternate the gate being closed. As the wind velocity decreases, the activator 62 and corresponding gate 61 will return to an original position. Optionally, the activator 62 may be provided with a spring to further bias the gate 61 in a closed position. As such, only wind velocity is used for mechanical switching of guide paths.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

What is claimed is:

1. A vertical axis wind turbine comprising:
a support structure having a directional vein and a plate with a guide track, the directional vein to change the position the guide track with changes in wind direction;
a shaft rotating in the support structure having a strut extending radially from the shaft; and
a strut flexibly coupled to a blade; the blade having a guide pin traveling within the guide track with the guide track controlling the pitch of the blade.

2. The device of claim 1, wherein the blade is rotatably coupled to the strut through a swivel assembly.

3. The device of claim 1 wherein the material of construction is primarily plastic.

4. A vertical axis wind turbine comprising:
a support structure having a directional vein and a plate with a first guide track and a second guide track, the directional vein to change the position of the plate with changes in wind direction;
a shaft rotating in the support structure having a strut extending radially from the shaft; and
a strut flexibly coupled to a blade; the blade having a guide pin traveling within the first guide track with the first guide track controlling the pitch of the blade.

5. The device of claim 4 having a diverter for directing the guide pin from the first guide track to the second guide track.

6. The device of claim 5 wherein the first guide track controls the pitch of the blade in a high lift condition with the second guide track controls the pitch of the blade in a high drag condition.

7. The device of claim 5 wherein the diverter is an aerodynamic diverter.

8. The device of claim 5 wherein the diverter is activated by changes in wind speed.

9. The device of claim 5 having a third guide track for reducing the blade speed during high wind conditions.

10. A method for operating a device including a support structure having a directional vein and a plate with a first guide track and a second guide track comprising the steps of;
changing the position of the plate with changes in wind direction;
rotating a shaft in the support structure having a strut extending radially from the shaft;
flexibly coupling the strut to a blade having a guide pin;
moving the blade traveling within the first guide track; and
controlling the pitch of the blade with the first guide track.

11. The method of claim 10, further comprising the step of directing the guide pin from the first guide track to the second guide track using a diverter.

12. The method of claim 10 further comprising activating the diverter by changing wind speed.

13. The method of claim 11, wherein the first guide track places the blade in a low drag position and the second guide track places the blade pitch in a high drag position.

14. The method of claim 11, further comprising the steps of including a third guide track for reducing the blade speed and protecting the device from wind damage.
